(19) United States
(12) Patent Application Publication
(10) Pub. No.: US 2016/0328148 A1
(43) Pub. Date: Nov. 10, 2016

(54) METHOD FOR CONTROLLING ELECTRONIC DEVICE AND ELECTRONIC DEVICE

(71) Applicant: BOE TECHNOLOGY GROUP CO., LTD., Beijing (CN)

(72) Inventors: Yanling HAN, Beijing (CN); Jiayang ZHAO, Beijing (CN); Xiangxiang ZOU, Beijing (CN)

(21) Appl. No.: 14/905,916

(22) PCT Filed: Jun. 16, 2015
(86) PCT No.: PCT/CN2015/081527

§ 371 Date: Jan. 18, 2016

(30) Foreign Application Priority Data
Jan. 9, 2015 (CN) 201510013175.0

(51) Int. Cl. G06F 3/0488; G06F 3/041; G06F 3/0489; G06K 9/00

(52) U.S. Cl. CPC G06F 3/04886; G06K 9/0002; G06F 3/0412; G06F 3/0416; G06F 3/04897

(57) ABSTRACT

The present invention relates to a method for controlling electronic device and a electronic device. The method for controlling electronic device comprises: acquiring fingerprint information and position information related to a touch operation of a user; identifying an instruction corresponding to the acquired fingerprint information and position information; and executing the corresponding instruction.

### FIELD OF THE INVENTION

Embodiments of the present invention relate to a method for controlling electronic device and an electronic device.

### BACKGROUND OF THE INVENTION

Generally, some shortcut keys are provided in electronic devices for the purpose of simplifying operation. Each shortcut key is associated with a certain instruction and corresponds to a certain function. In daily life, desktop computers or notebook computers are well-known electronic devices in which many shortcut keys are used.

In general, the shortcut keys are also called as hot keys, and refer to some specific keys, key sequence or key combination, which are used to complete an operation, and many shortcut keys are always used together with Ctrl key, Shift key, Alt key, Fn key and other function keys. As shown in FIG. 1, touch type shortcut keys 13 at the upper portion of a notebook keyboard are generally arranged in a row and used for realizing different functions, for instance, mute, volume adjustment and the like. In order to facilitate operation in a dark environment, the shortcut keys can also be designed to be luminous, thus ensuring that a user can make out the shortcut keys promptly in the dark environment.

The shortcut keys also have disadvantages while providing convenience for users. On the one hand, at present, there are many shortcut keys disposed on one touch control plane, which makes it difficult to touch and press accurately unless careful identification; and on the other hand, visual disturbance may be caused due to the illumination of the shortcut keys in the dark environment.

It is thus clear that it has become a technical problem urgent to be solved at present to optimize the shortcut keys operated in a touch control manner in an electronic device, such as a notebook computer.

### SUMMARY OF THE INVENTION

The technical problem to be solved by the present invention is to provide a method for controlling electronic device and an electronic device, so as to optimize a user interface while ensuring ease of use, in view of said disadvantages existing the prior art.

According to one aspect of the present invention, a method for controlling electronic device is provided, comprising: acquiring fingerprint information and position information related to a touch operation of a user; identifying an instruction corresponding to the acquired fingerprint information and position information; and executing the corresponding instruction.

According to an embodiment of the present invention, the step of identifying an instruction corresponding to the acquired fingerprint information and position information may comprise: receiving the acquired fingerprint information and position information; identifying a touch part corresponding to the fingerprint information, and identifying a touch orientation corresponding to the position information; looking up an instruction matched with the identified touch part and touch orientation in a stored mapping table; and sending the instruction.

According to an embodiment of the present invention, prior to the step of acquiring fingerprint information and position information related to a touch operation of a user, a step of setting and storing the touch parts and the touch orientations as well as instructions corresponding thereto is performed and comprises: receiving the acquired fingerprint information and position information; identifying a touch part corresponding to the fingerprint information, and identifying a touch orientation corresponding to the position information; setting an instruction corresponding to the identified touch part and touch orientation; and storing the touch part and the touch orientation in the mapping table in association with the corresponding instruction.

According to an embodiment of the present invention, the fingerprint information may comprise fingerprint information of at least one finger, and the position information may comprise information of N areas which are obtained by equally-dividing a peripheral region around the center of an acquisition area relatively to the center of the acquisition area, where N is an integer larger than or equal to 2.

According to an embodiment of the present invention, the instruction may comprise a brightness adjusting instruction for a display screen and a volume adjusting instruction for a system.

According to another aspect of the present invention, an electronic device is provided, comprising: a shortcut key, as an acquisition area, for acquiring fingerprint information and position information related to a touch operation of a user; a control unit for identifying an instruction corresponding to the fingerprint information and the position information acquired by the shortcut key; and an executing unit for executing the corresponding instruction.

According to an embodiment of the present invention, the control unit may comprise an information receiving module, an information identifying module, an instruction matching module and an instruction issuing module. The information receiving module is used for receiving the acquired fingerprint information and position information. The information identifying module comprises a fingerprint identifying component and an orientation identifying component, wherein the fingerprint identifying component is used for receiving the fingerprint information and identifying a touch part corresponding to the fingerprint information, and the orientation identifying component is used for receiving the position information and identifying a touch orientation corresponding to the position information. The instruction matching module is used for looking up an instruction matched with the touch part and the touch orientation identified by the information identifying module in a mapping table, wherein the mapping table is stored in a storage unit of the electronic device. The instruction issuing module is used for receiving the instruction found by the instruction matching module and sending the instruction to the executing unit.

According to an embodiment of the present invention, the electronic device may further comprise a setting unit for setting instructions corresponding to the touch parts and the touch orientations and storing the touch parts and the touch orientation in the mapping table of the storage unit in association with the corresponding instructions.

According to an embodiment of the present invention, the fingerprint information may comprise fingerprint information of at least one finger, and the position information may comprise information of N areas which are obtained by equally-dividing a peripheral region around the center of the shortcut key relatively to the center of the shortcut key, where N is an integer larger than or equal to 2.

According to an embodiment of the present invention, the instruction may comprise a brightness adjusting instruction for a display screen and a volume adjusting instruction for a system.

According to an embodiment of the present invention, the shortcut key may be operated in a touch control manner, and the shortcut key may be arranged on the same plane as a display screen or arranged to protrude out of the display screen.

According to an embodiment of the present invention, there may be one or more shortcut keys.

The method for controlling electronic device and the electronic device according to an embodiment of the present invention are capable of realizing multifunctional time division multiplexing of one or more shortcut keys operated in a touch control manner, and optimizing the user interface while ensuring ease of use, and thus are applicable to various products, such as a notebook computer, a mobile phone, and the like, having touch control and display functions.

### BRIEF DESCRIPTION OF THE DRAWINGS

The accompanying drawings are used for providing a further understanding of the present invention, constitute a part of the specification and are used to explain the present invention in conjunction with the specific embodiments below, rather than limit the present invention. In the drawings:

FIG. 1 is a schematic diagram of a user interface of an electric device in the prior art;

FIG. 2 is a flow diagram of a method for controlling electronic device according to an embodiment of the present invention;

FIG. 3 is a schematic diagram of a structure of the electronic device according to an embodiment of the present invention; and

FIG. 4 is a schematic diagram of the user interface of the electronic device according to an embodiment of the present invention.

### DETAILED DESCRIPTION OF THE EMBODIMENTS

In order to make those skilled in the art well understand the technical solutions of the present invention, a method for controlling electronic device and an electronic device of the present invention are further described in detail as below in conjunction with the accompanying drawings and the specific embodiments.

In the method for controlling electric device according to the embodiment, at least two kinds of information capable of being combined are acquired from the same acquisition area (for example, a shortcut key), so that the same acquisition area is used as multiple control keys executing different instructions in a time-sharing manner, so as to realize different functions.

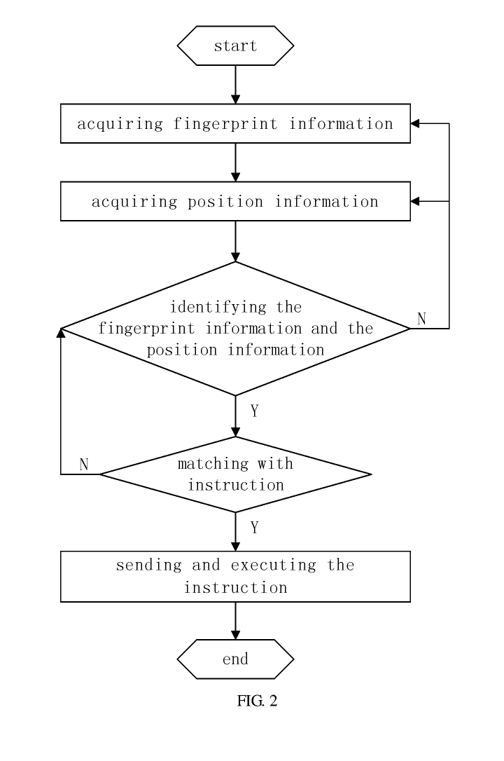

FIG. 2 is the flow diagram of the method for controlling electronic device according to an embodiment of the present invention.

Referring to FIG. 2, fingerprint information and position information are acquired at first. It should be noted that the sequence of acquiring the fingerprint information and acquiring the position information is not limited to that shown in FIG. 2. Moreover, the fingerprint information and the position information can also be acquired simultaneously.

Subsequently, the acquired fingerprint information and position information are identified. After both the fingerprint information and the position information are identified, an instruction matched with the fingerprint information and the position information is looked up. If either the fingerprint information or the position information (or both of them) cannot be identified, it returns to the step of acquiring fingerprint information and position information again.

After the matched instruction is found, the found instruction is sent, and if the matched instruction cannot be found, it returns to the step of identifying the fingerprint information and the position information again.

The matched instruction is executed after being received.

Concretely, in the step of acquiring the fingerprint information and the position information related to the touch operation of the user, the acquisition process is automatically accomplished by the acquisition area (for example, the shortcut key). The fingerprint information can comprise fingerprint information of at least one finger, and the position information can comprise information of N areas which are obtained by equally-dividing a peripheral region around the center of the acquisition area relatively to the center of the acquisition area, where N is an integer larger than or equal to 2.

In the step of identifying the instruction corresponding to the acquired fingerprint information and position information, the following steps may be included.

A step of receiving the acquired fingerprint information and position information. The received fingerprint information may be a set of data comprising fingerprint images, and the received position information can at least comprise data of initial position coordinates and data of ultimate position coordinates.

A step of identifying touch part corresponding to the fingerprint information and identifying touch orientation corresponding to the position information. The touch part can be identified via any conventional method in image identification, and the touch orientation can be identified via a method of comparing and judging the initial position coordinates and the ultimate position coordinates.

For example, the touch part can be identified according to the stored fingerprint information so as to identify which finger(s) of the user is (are) the current touch part. Moreover, the peripheral area around the center of the acquisition area can be equally-divided into N areas relatively to the center of the acquisition area so as to determine a relative position relationship between the initial position coordinates and the ultimate position coordinates according to the data of the initial position coordinates and the data of the ultimate position coordinates, thus identifying the touch orientation. For instance, when N is equal to 4, the peripheral area around the center of the acquisition area can be divided into four areas by 90 degrees, and therefore the touch orientation can comprise sliding upwards, downwards, leftwards and rightwards; and when N is equal to 8, the peripheral area around the center of the acquisition area can be divided into eight areas by 45 degrees, and therefore, the touch orientation can further comprise sliding towards top left, bottom left, top right, bottom right and the like. It should be appreciated that the value of N and the specific way of division are not limited in the present invention.

A step of looking up an instruction matched with the identified touch part and touch orientation in the stored mapping table. The lookup operation can be implemented by a conventional search method and will not be described in detail here.

A step of sending the instruction. The matched instruction is sent to a corresponding executing unit so as to execute the instruction.

Each executing unit executes the corresponding instruction after receiving the instruction.

The instruction can comprise a brightness adjusting instruction for a display screen, a volume adjusting instruction for a system and the like. For example, a thumb of the right hand may be set to be a mute operation, and when the touch part is identified to be the thumb of the right hand of the user, the mute operation can be performed by a volume adjusting unit of the system regardless of the touch orientation. Additionally, a forefinger of the right hand may be set to be a volume increase operation while sliding upwards and to be a volume decrease operation while sliding downwards; and a middle finger of the right hand may be set to be a brightness increase operation while sliding upwards and to be a brightness decrease operation while sliding downwards, and the like. Therefore, the volume or the brightness is correspondingly adjusted according to the touch part and the touch orientation while the instruction is executed.

In the method for controlling electronic device according to the embodiment of the present invention, the touch part represented by the fingerprint information and the touch orientation represented by the position information can be variously combined, and various combinations correspond to different instructions. Therefore, the method for controlling electronic device according to an embodiment of the present invention may also comprise steps of setting and storing instructions corresponding to the touch part and the touch orientation, and specifically comprise steps of: receiving the acquired fingerprint information and position information; identifying touch part corresponding to the fingerprint information, and identifying touch orientation corresponding to the position information; setting an instruction corresponding to the identified touch part and touch orientation; and storing the touch part, the touch orientation in the mapping table in association with the corresponding instruction.

By setting and storing the touch part, the touch orientation and the corresponding instructions, one shortcut key can be used as multiple control keys executing different instructions in a time-sharing manner, so as to realize different functions. Therefore, the control interface is simplified and the flexible user customization is realized.

The method for controlling electronic device according to the embodiment is capable of realizing multifunctional time-sharing multiplexing with one or more shortcut keys operated in a touch control manner, and optimizing the user interface while ensuring ease of use, and thus is applicable to various products, such as a notebook computer, a mobile phone, and the like, having touch control and display functions.

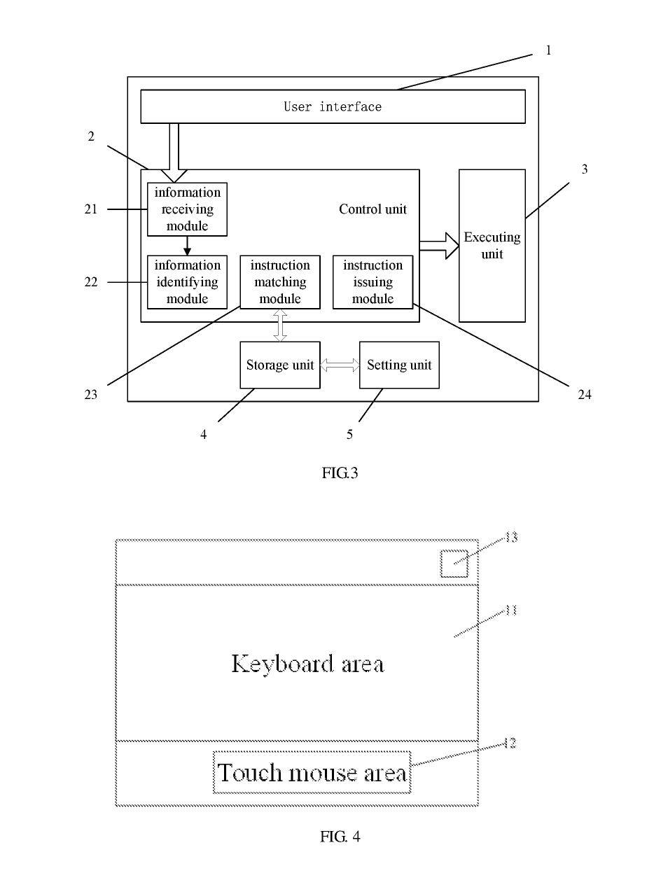

FIG. 3 is a schematic diagram of a structure of an electronic device according to an embodiment of the present invention. FIG. 4 is a schematic diagram of the user interface of the electronic device according to an embodiment of the present invention.

Referring to FIG. 3 and FIG. 4, the electronic device according to the embodiment may comprise a shortcut key 13, a control unit 2 and an executing unit 3. The shortcut key 13 may be disposed on the user interface 1 of the electronic device, and the control unit 2 and the executing unit 3 may be disposed inside the electronic device. FIG. 4 shows that the user interface 1 comprises a keyboard area 11, a touch mouse area 12 and the shortcut key 13.

In the electronic device according to the embodiment, the shortcut key 13 is the acquisition area for acquiring the fingerprint information and the position information related to the touch operation of the user. The fingerprint information may comprise fingerprint information of at least one finger, and the position information may comprise information of N areas which are obtained by equally-dividing a peripheral region around the center of the shortcut key 13 relatively to the center of the shortcut key 13, where N is an integer larger than or equal to 2.

The shortcut key 13 may have the function of acquiring the fingerprint information and the position information. The shortcut key 13 may be operated in a touch control manner, and the shortcut key 13 may be arrange on the same plane as the display screen or to protrude out of the display screen. According to one embodiment of the present invention, the shortcut key 13 is a capacitive touch key which can be used for acquiring the fingerprint information of the user and sending the fingerprint information to the control unit 2 for identification, so as to identify which finger is used by the user based on the fingerprint information representing the touch part. Moreover, the shortcut key 13 may be used for acquiring the position information and sending the position information to the control unit 2 for identification, so as to identify which gesture operation is performed by the user based on the position information representing the touch orientation. When the shortcut key 13 is formed to protrude out of the display screen, the touch operation on the shortcut key 13 is performed more conveniently.

The shortcut key 13 may be implemented into one or more shortcut keys. Moreover, it is advantageous to reduce the quantity of the shortcut keys 13 to one or two. In the method for controlling electronic device according to the embodiment of the present invention, the fingerprint information representing the touch part and the position information representing the touch orientation capable of being combined, so that one shortcut key 13 is used to realize multiple different functions in a time-sharing manner, and thus the user interface is optimized.

In the electronic device according to the embodiment, the control unit 2 is used for identifying the instruction corresponding to the fingerprint information and position information acquired by the shortcut key 13. As shown in FIG. 3, the control unit 2 may comprise an information receiving module 21, an information identifying module 22, an instruction matching module 23 and an instruction issuing module 24.

The information receiving module 21 is used for receiving the acquired fingerprint information and position information; the information identifying module 22 may comprise a fingerprint identifying component and an orientation identifying component, wherein the fingerprint identifying component is used for receiving the fingerprint information and identifying a touch part corresponding to the fingerprint information, and the orientation identifying component is used for receiving the position information and identifying a touch orientation corresponding to the position information. The instruction matching module 23 is used for looking up an instruction matched with the touch part and the touch orientation identified by the information identifying module 22 in a mapping table, wherein the mapping table can be stored in a storage unit 4 of the electronic device. The instruction issuing module 24 is used for receiving the instruction found by the instruction matching module 23 and issuing the instruction to the executing unit 3.

In the electronic device according to the embodiment, the executing unit 3 is used for executing a corresponding instruction. The executing unit 3 is configured to receive the instruction corresponding to the fingerprint information and position information acquired by the shortcut key 13 and execute the corresponding function.

As shown in FIG. 3, the electronic device may also comprise a setting unit 5. The setting unit 5 is used for setting instructions corresponding to the touch parts and the touch orientations and storing the touch parts and the touch orientations in a mapping table of the storage unit 4 in association with the corresponding instructions. A mapping relationship among the touch part, the touch orientation and the instruction in the mapping table can be newly added or altered by the setting unit 5 so as to realize flexible user customization.

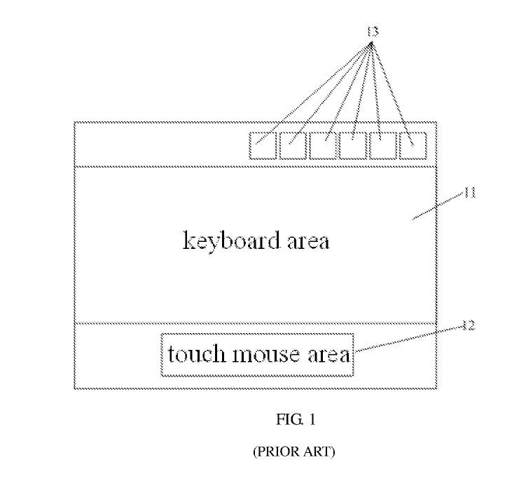

In the electronic device according to the present invention, a row of shortcut keys (as shown in FIG. 1) in the prior art is be optimized into one (or two) shortcut key(s) 13 as shown in FIG. 4. By corresponding different combinations of the touch part (fingers of the user) and the touch orientation to different instructions, one (or two) shortcut key(s) 13 is (are) used as multiple control keys executing different instructions in a time-sharing manner, so as to optimize the user interface while ensuring ease of use, and thus the electronic device is applicable to various products, such as a notebook computer, a mobile phone, and the like, having touch control and display functions.

It can be appreciated that the abovementioned embodiments are just exemplary embodiments adopted for illustrating the principle of the present invention, but the present invention is not limited thereto. For those skilled in the art, various modifications and improvements can be made without departing from the spirit and essence of the present invention, which are also deemed to fall into the protection scope of the present invention.

1. A method for controlling electronic device, comprising:
acquiring fingerprint information and position information related to a touch operation of a user;
identifying an instruction corresponding to the acquired fingerprint information and position information; and
executing the corresponding instruction.

2. The method for controlling electronic device of claim 1, wherein the step of identifying an instruction corresponding to the acquired fingerprint information and position information comprises:
receiving the acquired fingerprint information and position information;
identifying a touch part corresponding to the fingerprint information, and identifying a touch orientation corresponding to the position information;
looking up an instruction matched with the identified touch part and touch orientation in a stored mapping table; and sending the instruction.

3. The method for controlling electronic device of claim 2, wherein prior to the step of acquiring fingerprint information and position information related to a touch operation of a user, a step of setting and storing the touch parts and the touch orientations as well as instructions corresponding thereto is performed and specifically comprises:
receiving the acquired fingerprint information and position information;
identifying a touch part corresponding to the fingerprint information, and identifying a touch orientation corresponding to the position information;
setting an instruction corresponding to the identified touch part and the identified touch orientation; and
storing the touch part and the touch orientation in the mapping table in association with the corresponding instruction.

4. The method for controlling electronic device of claim 1, wherein the fingerprint information comprises fingerprint information of at least one finger, and the position information comprises information of N areas which are obtained by equally-dividing a peripheral region around the center of an acquisition area relatively to the center of the acquisition area, where N is an integer larger than or equal to 2.

5. The method for controlling electronic device of claim 1, wherein the instruction comprises a brightness adjusting instruction for a display screen and a volume adjusting instruction for a system.

6. An electronic device, comprising:
a shortcut key, used as an acquisition area, and configured to acquire fingerprint information and position information related to a touch operation of a user;
a control unit configured to identify an instruction corresponding to the fingerprint information and the position information acquired by said shortcut key; and
an executing unit configured to execute the corresponding instruction.

7. The electronic device of claim 6, wherein,
the control unit comprises an information receiving module, an information identifying module, an instruction matching module and an instruction issuing module, wherein,
the information receiving module is configured to receive the acquired fingerprint information and position information;
the information identifying module comprises a fingerprint identifying component and an orientation identifying component, wherein the fingerprint identifying component is configured to receive the fingerprint information and identify a touch part corresponding to the fingerprint information, and the orientation identifying component is configured to receive the position information and identify a touch orientation corresponding to the position information;
the instruction matching module is configured to look up an instruction matched with the touch part and the touch orientation identified by the information identifying module in a mapping table, wherein the mapping table is stored in a storage unit of the electronic device; and
the instruction issuing module is configured to receive the instruction found by the instruction matching module and send the instruction to the executing unit.

8. The electronic device of claim 7, further comprising a setting unit configured to set instructions corresponding to the touch parts and the touch orientations, and store the touch parts and the touch orientations in the mapping table of the storage unit in association with the corresponding instructions.

9. The electronic device of claim 6, wherein the fingerprint information comprises fingerprint information of at least one finger, the position information comprises information of N areas which are obtained by equally-dividing a peripheral region around the center of the shortcut key relatively to the center of the shortcut key, where N is an integer larger than or equal to 2.

10. The electronic device of claim 6, wherein the instruction comprise a brightness adjusting instruction for a display screen and a volume adjusting instruction for a system.

11. The electronic device of claim 6, wherein the shortcut key is operated in a touch control manner and is arranged on the same plane as a display screen or arranged to protrude out of the display screen.

12. The electronic device of claim 6, wherein there are one or more shortcut keys.
